(19) United States
(12) Patent Application Publication
(10) Pub. No.: US 2004/0040511 A1
(43) Pub. Date: Mar. 4, 2004

(54) Methods of injecting substances into eggs with reduced contamination

(76) Inventor: Christopher John Williams, Apex, NC (US)

Correspondence Address: MYERS BIGEL SIBLEY & SAJOVEC, PO BOX 37428, RALEIGH, NC, 27627, US

(21) Appl. No.: 10/628,061

(22) Filed: Jul. 25, 2003

Related U.S. Application Data
(60) Provisional application No. 60/402,274, filed on Aug. 9, 2002.

(51) Int. Cl. A01K 45/00

(52) U.S. Cl. 119/6.8

(57) ABSTRACT

A method of introducing a substance into an avian egg such that potential contamination is substantially reduced includes removing an avian egg containing a live avian embryo from an incubator; applying a sanitizing fluid to the shell of the egg to kill pathogens attached thereto; forming an opening in the shell; inserting an injection device through the opening; releasing a substance into the egg via the needle; retracting the injection device from the egg; and applying a sanitizing fluid to the needle to kill pathogens attached thereto. Prior to injection, the sanitizing fluid is applied to substantially the entire surface of the egg shell.

### RELATED APPLICATION

This application claims the benefit of U.S. Provisional Application No. 60/402,274 filed Aug. 9, 2002, the disclosure of which is incorporated herein by reference in its entirety as if set forth fully herein.

### FIELD OF THE INVENTION

The present invention relates generally to eggs and, more particularly, to methods and apparatus for treating eggs.

### BACKGROUND OF THE INVENTION

Injections of various substances into avian eggs have been employed to decrease post-hatch mortality rates, increase the potential growth rates or eventual size of the resulting chicken, and even to influence the gender determination of the embryo. Similarly, injections of antigens into live eggs have been employed to incubate various substances used in vaccines which have human or animal medicinal or diagnostic applications. Examples of substances that have been used for, or proposed for, in ovo injection include vaccines, antibiotics and vitamins. In addition, removal of material from avian eggs has been employed for various purposes, such as testing and vaccine harvesting.

Examples of in ovo substances and methods of in ovo injection are described in U.S. Pat. No. 4,458,630 to Sharma et al. and U.S. Pat. No. 5,028,421 to Fredericksen et al., the contents of which are incorporated by reference herein in their entireties. The selection of both the site and time of in ovo injection can also impact the effectiveness of the injected substance, as well as the mortality rate of the injected eggs or treated embryos. See, e.g., U.S. Pat. No. 4,458,630 to Sharma et al., U.S. Pat. No. 4,681,063 to Hebrank, and U.S. Pat. No. 5,158,038 to Sheeks et al., each of which is hereby incorporated by reference herein in its entirety.

Poultry eggs (hereinafter “eggs”) are typically inoculated on or about the eighteenth day of incubation. Typically, eggs are held in flats on racks in carts for incubation in relatively large incubators. At a selected time, typically on the eighteenth day of age, a cart of eggs is removed from the incubator for the purposes of inoculation. Typically, all eggs are inoculated, including non-viable eggs. Ideally, however, separating out non-viable eggs (namely, dead eggs, rotted eggs, empties, and clear eggs) and inoculating only the live eggs should occur at the eighteenth day of incubation.

Conventionally, devices for injecting material into eggs and for removing material from eggs are configured to pierce and enter an egg along a generally vertical direction. Eggs are generally positioned in an upright, vertical orientation with the longitudinal axis of the egg substantially aligned with vertical.

Egg injection techniques incorporate aseptic (sterile) introduction of a needle through the shell of an egg and subsequently through the chorioallantoic membrane below the blunt end of an egg. The sterility of the injection solution (diluent or media) should be maintained. The introduction of bacteria, microbes, viruses and other pathogens into a developing embryo may be lethal as well as cause depressed growth and development if the embryo survives. Depending upon the characteristics of the specific pathogen, the number needed to cause problems can be very small (e.g., 1-10 bacteria colony forming units (cfu)).

Typically, egg injection systems address the issue of pathogen invasion through the use of sanitizing fluid (e.g., a buffered chlorine solution) that bathes the injection device between egg injections. In addition, an antibiotic or other sanitizing agent may be incorporated into an injection solution. This can be effective in the prevention of infection in most cases; however, pathogen carryover (from a contaminated egg to a clean egg) can occur. Furthermore, the exterior and interior (lumen) of injection devices have been shown to be actual sites of pathogen carryover.

### SUMMARY OF THE INVENTION

In view of the-above discussion, a method of introducing a substance into an avian egg such that potential contamination is substantially reduced includes removing an avian egg containing a live avian embryo from an incubator; applying a sanitizing fluid to the shell of the egg to kill pathogens attached thereto; forming an opening in the shell; inserting an injection device through the opening; releasing a substance into the egg via the needle; retracting the injection device from the egg; and applying a sanitizing fluid to the needle to kill pathogens attached thereto. Prior to injection, the sanitizing fluid is applied to substantially the entire surface of the egg shell, with priority given to the site of shell penetration. After injection, the sanitizing fluid is applied to each part of the injection device that came into contact with the egg, including the interior and exterior of the punch tube and the exterior of the injection needle.

The injection device includes an elongated needle formed from a hollow tube having a free end that is angled with respect to a longitudinal axis of the tube. The free end has an opening surrounded by a planar, peripheral surface, and is angled with respect to the longitudinal axis of the tube. In addition, the needle has a thickness that is smaller than 20 gauge. The opening in the egg is formed via a tubular punch and the elongated needle is moved through the tubular punch and then through the opening formed in the shell. The severity of pathogen carryover from one egg to the next can be reduced dramatically if the cross-sectional area of the needle is less than or equal to forty percent (40%) of the cross sectional area of the bore of the punch within which the needle is movably secured.

In ovo injection of substances according to embodiments of the present invention substantially reduces the potential for contamination as compared with conventional in ovo injection methods.

### BRIEF DESCRIPTION OF THE DRAWINGS

FIG. 1 is a side view of a multiple in ovo injection head apparatus.

FIG. 2 is an enlarged view of an injection head in the multiple injection head apparatus of FIG. 1.

FIG. 3A is an enlarged side view of an in ovo injection needle, according to embodiments of the present invention.

FIG. 3B is a side view of the needle of FIG. 3A taken along lines 3A-3A.

FIG. 4 is a flow chart illustrating operations for injecting substances into eggs such that the potential for contamination is substantially reduced, according to embodiments of the present invention.

FIG. 5A is an enlarged, side sectional view of the injection head of FIG. 2 illustrating a punch and needle disposed within the punch.

FIG. 5B is a cross-sectional view of the needle and punch of FIG. 5A taken along lines 5B-5B.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The term “treatment substance” refers to a substance that is injected into an egg to achieve a desired result. Treatment substances include but are not limited to vaccines, antibiotics, vitamins, virus, and immunomodulatory substances. Vaccines designed for in ovo use to combat outbreaks of avian diseases in hatched birds are commercially available. Typically, the treatment substance is dispersed in a fluid medium, (e.g., a fluid diluent or emulsion) or is a solid dissolved in a fluid, or a particulate dispersed or suspended in a fluid.

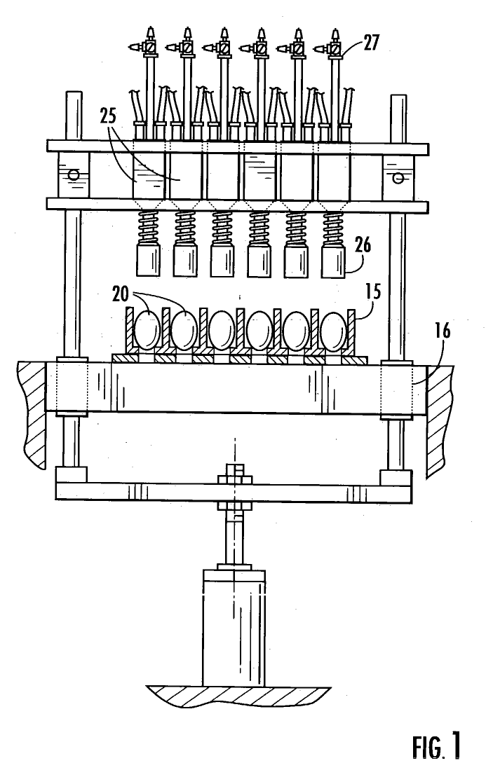

Referring to FIG. 1, an exemplary egg injection apparatus is illustrated and includes a flat 15 for carrying eggs, a stationary base 16, and a plurality of conventional injection delivery devices, or heads, 25 with fluid delivery means such as lumens or needle(s) positioned therein in accordance with known techniques. The flat 15 holds a plurality of eggs 20 in a substantially upright position. The flat 15 is configured to provide external access to predetermined areas of the eggs 20. Each egg is held by the flat 15 so that a respective end thereof is in proper alignment relative to a corresponding one of the injection devices 25 as the injection device 25 advances towards the base 16 of the apparatus. As used herein, a “lumen” is a cavity or inner open space of a tube which can be provided by a syringe or needle. A lumen for delivery of a treatment substance may be within a needle, or between a needle and an outer guide or sleeve. Multiple lumens may be formed within a single needle, with the outlet ports positioned on different locations on the needle.

Each of the plurality of injection devices 25 has opposing first and second ends 26, 27. The devices 25 have a first extended position and a second retracted position, as is known in the art. Upon extension of the injection device 25, the first end 26 is configured to contact and rest against predetermined areas of the external egg shell. When not injecting, the injection devices 25 are retracted to rest a predetermined distance above the eggs and stationary base 16. The second end 27 of the injection delivery device includes first and second inlet ports 28a, 28b which are configured to receive tubing respectively from treatment substance chambers. The treatment substances can then be delivered within the needle along separate delivery paths, such as the lumen of an inner needle, and the space between the inner needle and a guide punch.

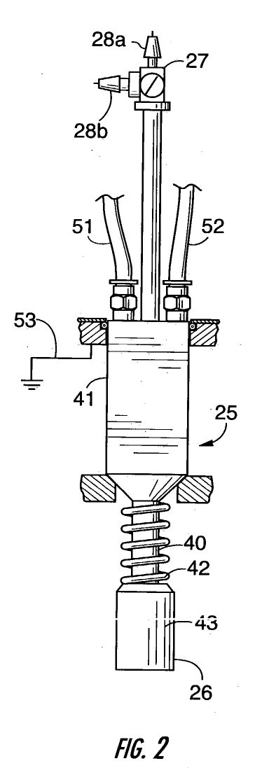

As shown in FIG. 2, the illustrated in ovo injection head 25 of FIG. 1 includes a body member 40 having opposing top and bottom end portions 41, 43 and an elongate longitudinal aperture formed therein, and a delivery device positioned in said aperture. The device includes an egg locating member, or egg engaging member, on end portion 26, which is slidably connected to the body member and includes a spring 42 to both cushion the engagement, and hold the egg in place during the downstroke of the injection head. An outer guide is provided to pierce the egg shell, and a needle then extends beyond the outer guide and into the desired compartments of the egg.

Surprisingly, Applicant has discovered that the severity of pathogen carryover from one egg to the next via an in ovo injection device can be reduced by reducing the diameter of an injection needle, by increasing the volume of sanitation fluid per needle per cycle, or a combination of both needle size reduction and increased sanitation volume, and by treating the shell of eggs after incubation with a sanitizing fluid to kill pathogens thereon. Smaller diameter needles may permit greater clearance between the needle and the punch within which the needle is operably associated with.

According to embodiments of the present invention, needle size has been decreased to less than 20 gauge and the volume of sanitation fluid used to sanitize each needle after an injection has been increased to about 500-600 μl.

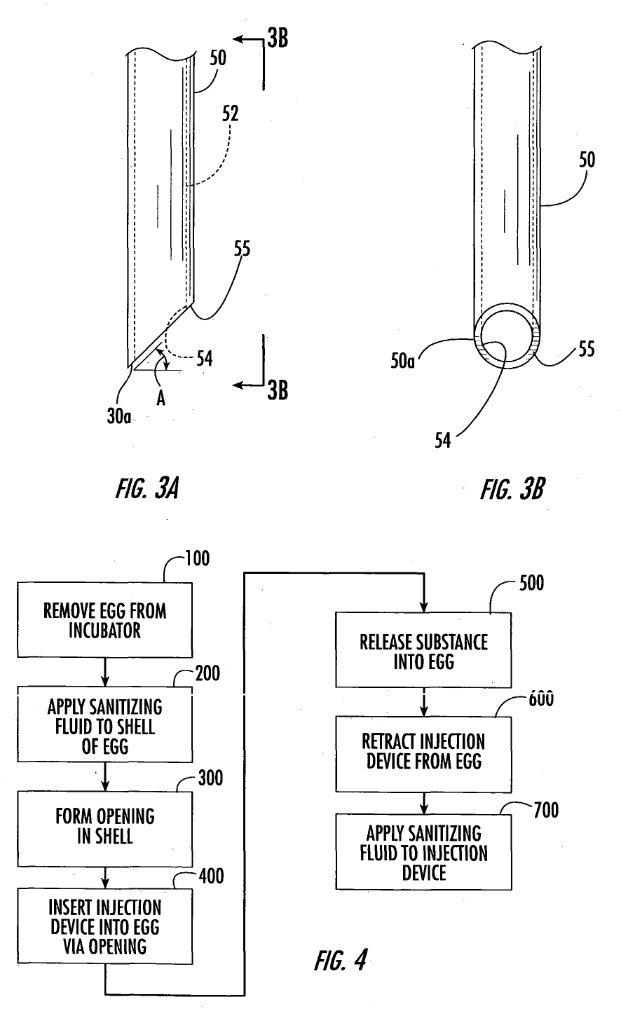

FIGS. 3A-3B are enlarged partial illustrations of an in ovo injection needle 50 according to embodiments of the present invention. The illustrated needle 50 is a hollow tube having a lumen 52 through which-material to be injected into an egg flows from a source. The lumen terminates at an opening 54 in the free end 50a of the needle 50. The free end is angled with respect to a longitudinal axis L of the tube. The lumen opening 54 is surrounded by a planar, peripheral surface 55 as illustrated. The angle A of the end 50a may be virtually any angle. An angle between about thirty degrees and sixty degrees (30°-60°) is preferred, and an angle of forty-five degrees (45°) is particularly preferred. The illustrated end 50a has an angle A of about 45°.

Conventional needles utilized for subcutaneous injection have an end portion with a three-dimensional configuration (B-bevel). This three-dimensional configuration can serve as a host site for pathogens. In contrast, Applicant has found that the flat, angled configuration of the needle end 50a illustrated in FIGS. 3A-3B reduces the surface area that can serve as a host site for pathogens.

Needle thickness is referred to as “gauge.” The higher the gauge, the thinner the needle. For example, a 30 gauge needle is thinner than a 28 gauge needle. Conventional in ovo injection needles are utilized to punch through the shell of an egg. Injection needles thinner than about 20 gauge are considered too thin to repetitively penetrate an egg shell without bending. As such, conventional egg injection needles are thicker than 20 gauge.

Because the injection needle of the present invention is not utilized for punching through the shell of an egg, the needle thickness can be much smaller than conventional injection needles. According to embodiments of the present invention, the needle 50 has a thickness that is smaller than 20 gauge. By utilizing smaller needles, the amount of surface area of the needle that can serve as a host site for pathogens is further reduced.

Referring now to FIG. 4, a method of introducing a substance into an avian egg such that potential contamination is substantially reduced includes removing an avian egg containing a live avian embryo from an incubator (Block 100); applying a sanitizing fluid to the shell of the egg to kill pathogens attached thereto (Block 200); forming an opening in the shell (Block 300); inserting an injection device through the opening (Block 400); releasing a substance into the egg via the needle (Block 500); retracting the injection device from the egg (Block 600); and applying a sanitizing fluid to the needle to kill pathogens attached thereto (Block 700).

Prior to injection, the sanitizing fluid is applied to substantially the entire surface of the egg shell; however, primary concentration should be upon the site of shell penetration. After injection, the sanitizing fluid is applied to each part of the injection device that came into contact with the egg, including within the needle hollow tube.

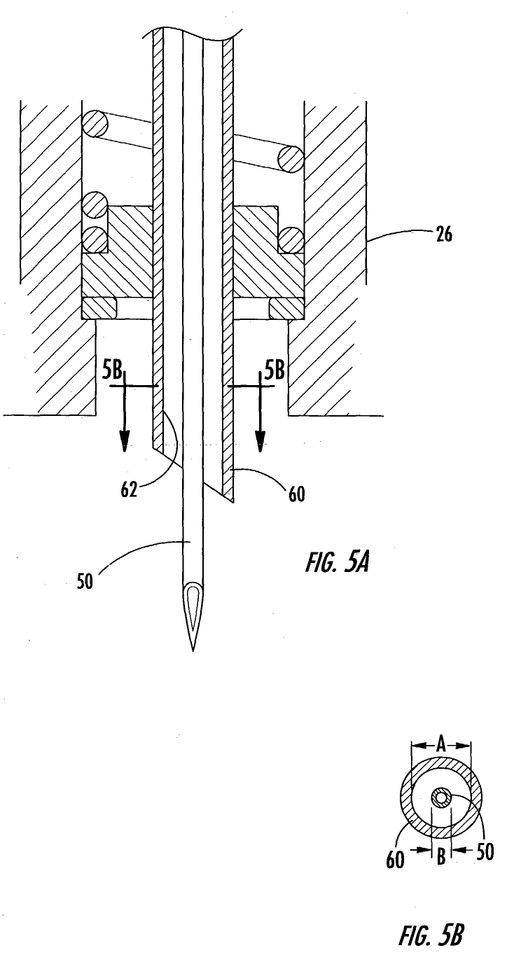

According to embodiments of the present invention, the opening in an egg is formed via a tubular punch (60, FIG. 5A). An elongated needle 50 is movably secured within the tubular punch 60 and is configured to be inserted into the opening formed in the shell by the punch 60. U.S. Pat. Nos. 4,681,063; RE 35,973; 5,136,979; 6,032,612, each of which is assigned to the assignee of the present invention, Embrex, Inc., describe forming an opening in the shell of an egg with a tubular punch and then moving an injection needle through the tubular punch and then through the opening formed in the shell of the egg, and then injecting a substance through the needle and into the egg. The disclosures of each of these patents are incorporated herein by reference in their entireties.

Surprisingly, Applicant has discovered that the severity of pathogen carryover from one egg to the next can be reduced dramatically if the cross-sectional area of a needle is less than or equal to forty percent (40%) of the cross sectional area of the bore of a punch within which the needle is movably secured. For example, as illustrated in FIG. 5B, the cross-sectional area A₁ of needle 50 is Π*(B/2)² and the cross-sectional area A₂ Of the bore 62 of punch needle 60 is Π*(A/2)². The severity of pathogen carryover from one egg to the next can be reduced dramatically if A₁≦0.4A₂.

Applicant's discovery can also be described relative to volumes. For example, the severity of pathogen carryover from one egg to the next can be reduced dramatically if the volume needle 50 displaces is less than or equal to forty percent (40%) of the internal volume of the tubular punch 60.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A method of introducing a substance into an avian egg, comprising:
applying a sanitizing fluid to the shell of the egg to kill pathogens attached thereto;
forming an opening in the shell;
inserting an injection device through the opening and into an interior portion of the egg, wherein the injection device comprises an elongated needle, wherein the needle comprises a hollow tube having a free end, and wherein the needle has a thickness that is smaller than 20 gauge;
releasing a substance into the egg via the needle;
retracting the injection device from the egg; and
applying a sanitizing fluid to the needle to kill pathogens attached thereto.

2. The method of claim 1, wherein the sanitizing fluid is applied to substantially the entire surface of the egg shell.

3. The method of claim 1, wherein the free end is angled with respect to a longitudinal axis of the tube and has an opening surrounded by a planar, peripheral surface.

4. The method of claim 4, wherein the free end is angled between about thirty degrees and about sixty degrees (30°-60°) with respect to the longitudinal axis of the tube.

5. The method of claim 4, wherein the free end is angled by about forty-five degrees (45°) with respect to the longitudinal axis of the tube.

6. The method of claim 1, wherein forming an opening in the shell comprises forming the opening with a tubular punch, and wherein inserting an injection device through the opening comprises moving the elongated needle through the tubular punch and then through the opening formed in the shell.

7. The method of claim 6, wherein the sanitizing fluid is applied to internal and external portions of the tubular punch.

8. The method of claim 1, wherein the needle has a thickness that is smaller than 20 gauge.

9. The method of claim 7, wherein the tubular punch has an internal bore, and wherein a cross-sectional area of the elongated needle is less than or equal to forty percent (40%) of a cross-sectional area of the internal bore of the tubular punch.

10. The method of claim 7, wherein the tubular punch has an internal bore that defines an internal volume, and wherein a volume displaced by the elongated needle is less than or equal to forty percent (40%) of the internal volume of the tubular punch.

11. The method of claim 1, wherein the step of applying a sanitizing fluid to the shell of the egg is preceded by removing the egg from an incubator.

12. A method of introducing a substance into an avian egg, comprising:
removing an avian egg from an incubator, wherein the egg contains a live avian embryo;
applying a sanitizing fluid to substantially the entire surface of the shell of the egg to kill pathogens attached thereto;
forming an opening in the shell;
inserting an injection device through the opening and into an interior portion of the egg, wherein the injection device comprises an elongated needle, wherein the needle comprises a hollow tube having a free end that is angled with respect to a longitudinal axis of the tube, wherein the free end has an opening surrounded by a planar, peripheral surface, wherein the free end is angled between about thirty degrees and about sixty degrees (30°-60°) with respect to the longitudinal axis of the tube, and wherein the needle has a thickness that is equal to or smaller than 20 gauge;
releasing a substance into the egg via the needle;
retracting the injection device from the egg; and
applying a sanitizing fluid to the needle to kill pathogens attached thereto.

13. The method of claim 12, wherein the free end is angled by forty-five degrees (45°) with respect to the longitudinal axis of the tube.

14. The method of claim 12, wherein forming an opening in the shell comprises forming the opening with a tubular punch, and wherein inserting an injection device through the opening comprises moving the elongated needle through the tubular punch and then through the opening formed in the shell.

15. The method of claim 14, wherein the sanitizing fluid is applied to internal and external portions of the tubular punch.

16. The method of claim 12, wherein the needle has a thickness that is smaller than 20 gauge.

17. The method of claim 14, wherein the tubular punch has an internal bore, and wherein a cross-sectional area of the elongated needle is less than or equal to forty percent (40%) of a cross-sectional area of the internal bore of the tubular punch.

18. The method of claim 14, wherein the tubular punch has an internal bore that defines an internal volume, and wherein a volume displaced by the elongated needle is less than or equal to forty percent (40%) of the internal volume of the tubular punch.
